(19) United States
(12) Patent Application Publication
(10) Pub. No.: US 2009/0326832 A1
(43) Pub. Date: Dec. 31, 2009

(54) GRAPHICAL MODELS FOR THE ANALYSIS OF GENOME-WIDE ASSOCIATIONS

(75) Inventors: David E. Heckerman, Bellevue, WA (US); Carl M. Kadie, Bellevue, WA (US); Hyunmin Kang, Los Angeles, CA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/163,774

(22) Filed: Jun. 27, 2008

(51) Int. Cl. G06F 19/00; G06G 7/48

(52) U.S. Cl. 702/20; 703/11

(57) ABSTRACT

Systems and methods are provided for the identification of genotype-phenotype associations in genome-wide association (GWA) studies. In an illustrative implementation, a data correlation environment comprises a population structure engine and at least one instruction set to instruct the population structure engine to process pedigree or population genetic data to generate a population structure sub-model according to a selected graphical model-based data correlation paradigm. Illustratively, the parameter of the resulting generalized linear mixed model can be learned using a variational approximation.

### BACKGROUND

The search for correlations in many types of data, such as biological data, can be difficult if the data are not exchangeable or independent and identically distributed (IID). For example, a set of viral sequences are rarely exchangeable because they are derived from a phylogeny or an evolutionary tree. In other words, some sequences are very similar to each other but not to others due to their position in the evolutionary tree. This phylogenetic structure can confound the statistical identification of associations. The problem is similar in genome wide association (GWA) studies, where one seeks to identify single nucleotide polymorphisms (SNPs) that are correlated with various human phenotypes such as propensity to disease. The inability to reproduce results across GWA studies is likely due in part to confounding by population structure of the DNA sequences. Other areas in which population structure may confound the statistical identification of associations include the identification of coevolving residues in proteins given a multiple sequences alignment and the identification of Human Leukocyte Antigen (HLA) alleles that mediate escape mutations of the Human Immunodeficiency Virus (HIV).

Genome-wide association (GWA) studies are used for personalized medicine. In such studies, the genotype of individuals is correlated with various types of phenotypes such as whether a person has or will get a disease, whether a person's disease will recur, and whether a person will react well or badly to treatment. A significant shortcoming with current analysis methods is weak power. That is, it is difficult for current methods to find a signal in the very noisy data that is obtained. Typical datasets include one to fifty thousand individuals, approximately one million single nucleotide polymorphisms (SNPs) (i.e., a sample of one's DNA), and a few phenotypes—although these numbers are ever increasing

Genetic association studies have faced many challenges with the rapid improvement of genotyping technologies. One of the biggest challenges is the confounding effect by population structure inducing false positives. Under the null model, the disease trait is not expected to be associated with the marker, but the hidden confounding from population structure may induce a spurious association by violating the assumption that marker and disease traits are independent and identically distributed (iid) across individuals. Such a problem has been recognized for over a decade and there has been various methods to correct for the bias due to population structure.

Generally, current practices prescribe two different ways to correct for the population structure. One is to re-estimate the null distribution of the statistics given a large number of genome-wide markers based on the assumption that only a small fraction of them can be associated with the disease trait—for example, genomic control and weighted permutation are techniques that have been widely used. These methods provide a simple method for correcting for the population structure, but may suffer from weak power when the confounding effect from the population structure is large. A second approach is to project the population structure onto a low dimensional space, and then test for associations among the projected data. One such method that is widely used is EIGENSTRAT, which can scale to millions of SNPs. Such methods can effectively correct for spurious associations induced by distinct subpopulations and their admixtures.

However, for more complex and cryptic relatedness involving familial relatedness and multi-leveled population structure, they may only partially capture the inflated false positives, thereby suffering from residual confounding. Recently, it has been suggested that the correction for population structure can be much improved by incorporating a more general model than a fixed dimensional vector for representing the population structure and genetic relatedness.

Current practices do not leverage the use of graphical models that offer a methodology for analysis that are computationally efficient, powerful, and intuitive. Graphical models when deployed can derive their power from the ability to represent the population structure of the data—that is the structure of the data resulting from inheritance of DNA.

From the foregoing it is appreciated that there exists systems and methods to ameliorate the shortcomings of existing practices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The subject matter described herein facilitates identifying associations between high density genotype markers and phenotypes in genome-wide association (GWA) studies. In an illustrative implementation, a data correlation environment comprises a population structure engine and at least one instruction set to instruct the population structure engine to process data representative of genotype and phenotype data to generate correlated genotype/phenotype data (e.g., identification of associations between predictor variables (e.g., single nucleotide polymorphisms—SNPs) and target variables (e.g., phenotypes)) according to a selected graphical model-based data correlation paradigm deploying at least one observation graphical model and a population structure sub-model optionally derived from the observation model.

In an illustrative operation, genotype/phenotype data can be received by the exemplary population structure engine for processing according to the exemplary instruction sets and the selected graphical model-based data correlation paradigm. In the illustrative operation, a population structure sub-model is operatively developed according to the selected graphical model-based data correlation paradigm. Illustratively, the population structure sub-model can be used alone or in combination with the SNP data to predict phenotypes for GWA studies.

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

FIG. 1 is a block diagram of one example of an exemplary graphical model for use in phenotype prediction in accordance with the herein described systems and methods.

FIG. 2 is a block diagram of one example of the interaction of one or more components of a population structure sub-model in accordance with the herein described systems and methods.

FIG. 3 is a block diagram of one example of a system for predicting phenotypes according to a graphical model-based data correlation paradigm in accordance with the herein described systems and methods.

FIG. 4 is a block diagram of one example of a system for predicting phenotypes according to a graphical model-based data correlation paradigm in accordance with the herein described systems and methods.

FIG. 5 is a block diagram of another example of a system for predicting phenotypes according to population structure sub-model.

FIG. 6 is a flow diagram of one example of a method of predicting phenotypes according to a graphical model based paradigm.

FIG. 7 is a flow diagram of one example of a method of predicting phenotypes according to a graphical model employing one or more selected sub-models.

FIG. 8 is a flow diagram of one example of a method of predicting phenotypes deploying a population structure sub-model operating on predictor variables and target variables.

FIG. 9 is a flow diagram of one example of a method of predicting phenotypes deploying a population structure sub-model deploying SNP data in accordance with the herein described systems and methods.

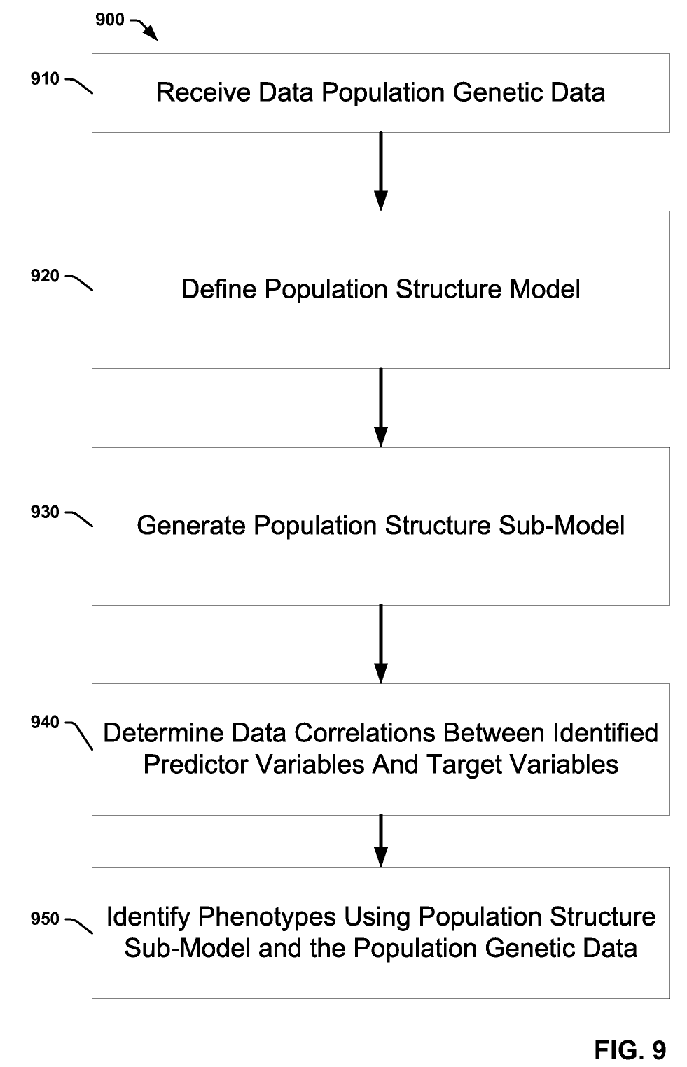

FIG. 10 is an example computing environment in accordance with various aspects described herein.

FIG. 11 is an example networked computing environment in accordance with various aspects described herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Artificial intelligence (AI) can be employed to identify a specific context or action, or generate a probability distribution of specific states of a system or behavior of a user without human intervention. Artificial intelligence relies on applying advanced mathematical algorithms—e.g., decision trees, neural networks, regression analysis, cluster analysis, genetic algorithm, and reinforced learning—to a set of available data (information) on the system or user.

Although the subject matter described herein may be described in the context of illustrative illustrations to predict correlations between genotype and phenotype data the subject matter is not limited to these particular embodiments. Rather, the techniques described herein can be applied to any suitable type of phenotype prediction methods, systems, platforms, and/or apparatus.

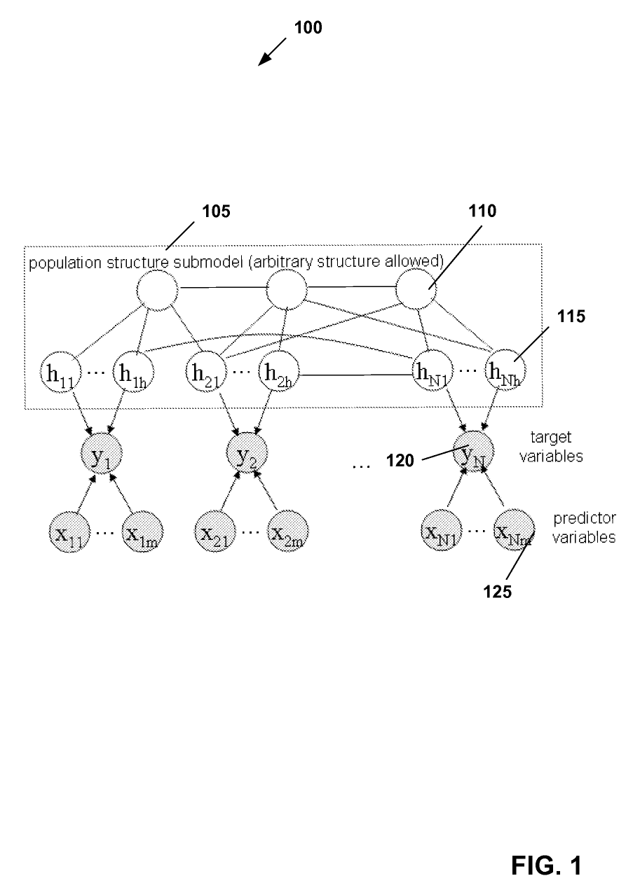

In an illustrative implementation, the herein described systems and methods consider the identification of phenotypes with the application of population structure model. FIG. 1 provides a block diagram of an exemplary form of an exemplary graphical model for this task. As is shown in FIG. 1, exemplary data correlation environment 100 comprises population structure sub-model 105 having multiple nodes 115 with numerous target variables 120 and predictor variables 125. In an illustrative implementation, node Yⱼ denotes the target variable for individual j. The nodes Xⱼ₁, . . . , Xⱼₘ can illustratively denote the predictor variables for the jth target variable. The nodes Hⱼ₁, . . . , Hⱼₕ can illustratively summarize the effect of the population structure on Yⱼ. Illustratively, the shaded nodes are those whose corresponding variables are observed. Exemplary, population structure sub model 110 can operatively reflect the dependencies among the H variables and may include additional hidden variables. The local distributions p(yⱼ|hⱼ₁, . . . , hⱼₕ, xⱼ₁, . . . , xₕₘ) can be identical (and therefore share the same parameters) for all j. In the illustrative implementation, such exemplary common local distribution can be considered as an exemplary observation sub-model.

In the illustrative implementation, the degree of association between a set of predictor variables x₁ₖ, . . . , x_{Nk} and the set of target variables y₁, . . . , y_{N}, can illustratively be determined by the strength of the arcs between those variables. This strength can be measured in many ways including a likelihood ratio test (i.e., which compares the likelihood of the data in two maximum-likelihood models: one with and one without the arcs between these variables) and a Bayesian score such as BIC (e.g., which also compares the likelihood of the data in these two models). When considering many target variables, adjustments for multiples comparisons can be done with, for example, the false discovery rate.

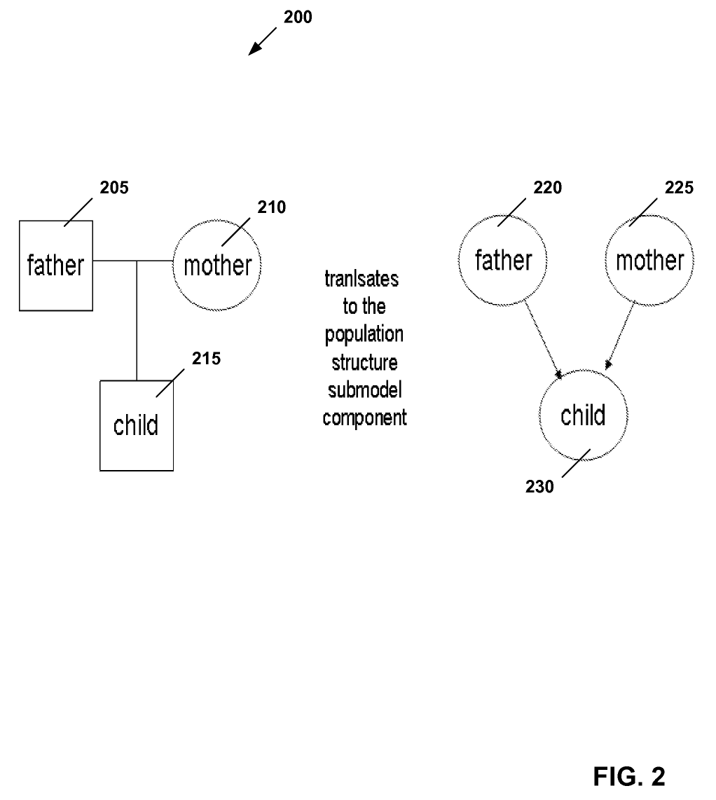

FIG. 2, illustratively describes an exemplary data correlation environment 200 wherein an exemplary population structure sub-model can be derived from a selected pedigree. As is shown, data correlation environment 200 comprises a genotype data elements 205, 210, and 215 that can illustratively describe the relationships of an observed family unit (e.g., father, mother, and child, respectively). Data correlation environment 200 can translate the pedigree elements into population structure sub-model components 220, 225, and 230, respectively. In the population structure sub-model, the distribution of the child given the parents is given by the linear-Guassian relationship p(child|mother,father)˜Gaussian(½*(mother+father), sigmâ2).

Often, the pedigree is incomplete. However, additional arcs in the population structure sub-model can be learned from the population genetic data using standard methods for learning linear-Gaussian DAG models.

### Population Structure Graphical Models:

In an illustrative implementation, the herein described systems and methods can operate/deploy one or more of the following operations/features comprising 1) a variational method for learning the parameters of a generalized linear mixed model, wherein the observation sub-model is logistic regression; 2) the target variable is continuous and predictor variables are continuous or binary; 3) each individual is associated with a single continuous hidden variable; and 4) where the population structure sub-model among these hidden variables is a multivariate-Gausssian distribution represented as a linear-Gaussian DAG model, which is derived from a selected pedigree and population genetic data. For the purposes of the herein described systems and methods, a trivial population structure sub-model as one that comprises a multivariate-Gaussian distribution with no independent constraints.

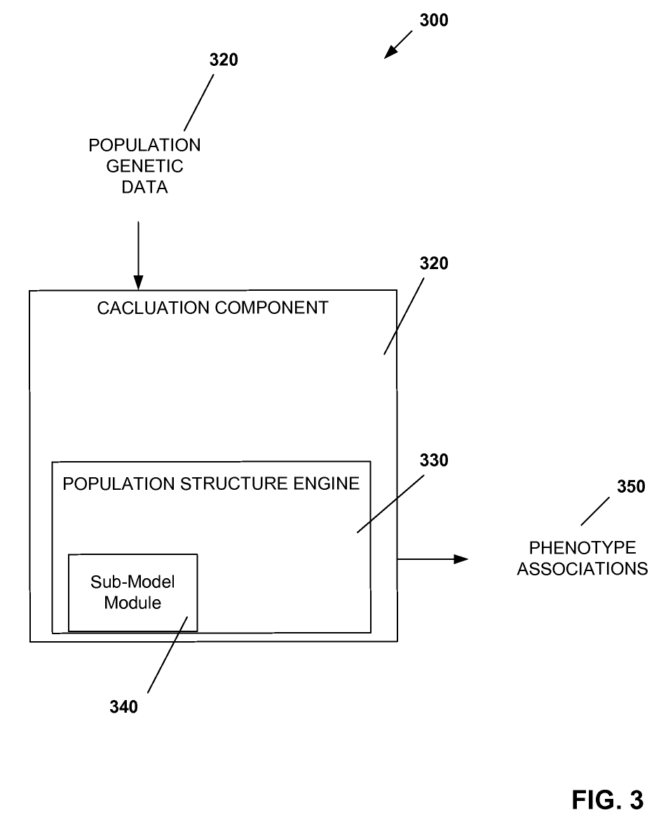

In an illustrative implementation, population structure sub-model 350 can be applied to data elements to identify phenotypes associated with a particular target according to the relative strengths/weaknesses of the relationships between the various data sets as described by the exemplary graphical models illustrated in FIGS. 3 and 3A. In an illustrative operation, data collected from the population sub-model components (e.g., father 352, mother 354, and child 356) can be processed according to one or more selected graphical model associations (as described by the arrows originating from one or more locus points from one or more sides) to identify phenotypes 358. In the illustrative operation, one or more resultant data sets 362, 364, 368, 370, and 376-386 can be generated as part of the identification of marker-phenotype associations.

A difficulty in applying Generalized Linear Mixed Models (GLMM) is that statistical inference is computationally much more inefficient than in, for example, a linear mixed model. The likelihood computation in a GLMM is typically intractable because it involves an integral over the high dimensional space of hidden variables. McCulloch et al. suggested several methods to approximate the likelihood in GLMM using a Monte Carlo approach combined with the EM algorithm, Newton-Raphosn algorithm, or importance sampling, both in probit-normal and logit-normal models.

Their methods are mainly targeted for relatively small number of dimensional datasets with block-structured variance components. When the number of dimensions becomes large and the variance component becomes complicated, the Monte-Carlo methods require a very large number of samples, so the accuracy and the stability estimated likelihood becomes poor. There are other approaches to perform a computationally more robust likelihood estimation in GLMM, but they do not provide enough scalability for genome wide case-control studies typically involving hundreds or thousands of individuals. The herein described systems and methods provide a method for case-control association mapping (i.e., identifying associations when the phenotype is a binary variable) under GLMM by applying a variational approximation.

Variational methods have a long history in physics, statistics, control theory, and economics, for approximate statistical inferences and estimations. They provide a computationally tractable approach for computing lower and upper bounds of the likelihood. The likelihood bound is often tight enough to use as an approximation for the exact likelihood.

Various methodologies have been developed for case-control association mapping. Included in such methodologies include the Probit-normal GLMM by McCulloch. The following describes a logit-normal GLMM for case-control studies.

Consider a case-control association study involving n individual samples. The individuals have binary phenotypes r=(r₁, r₂, . . . , rₙ)ε{−1, 1}ⁿ. A n×p matrix of fixed effects X includes mean, snps, and other confounding variables. Ignoring population structure for the moment, we can model each rᵢ given fixed effects xᵢ independently, according to the following logit model

Pr(rᵢ|xᵢ)=η(rᵢXᵢ^{t}β)=1/(1+exp(−rᵢxᵢ^{t}β))

The log-likelihood of the complete data can be formulated as

$$log Pr ( r ) = - {\sum }_{i = 1}^{n} log ( 1 + exp ( - {r}_{i} {x}_{i} β ) )$$

The optimal parameter β can be obtained by using the iteratively-reweighted least square method(IRLS). By excluding or including the SNPs in X, a likelihood ratio test can be performed between null hypothesis and alternative hypothesis to assess the significance of the SNP effect. If the individuals are related via complex population structure and familial relatedness, a pair of individuals genetically close to each other has a higher probability of having the same phenotypes than others. In this case, the overall likelihood cannot be simply computed by summing the individual likelihoods, because the assumption of independence is no longer valid. Using a logit-normal generalized linear mixed model (GLMM), the likelihood of the observed phenotypes can be formulated as a multidimensional integral form over hidden quantitative variables.

$$y = X β + u$$

$$Pr ( {r}_{i} \vert {y}_{i} ) = η ( {r}_{i} ( {wy}_{i} + b ) )$$

$$Pr ( r ; {σ}^{2} , X β , w , b ) = {\int }_{y ∈ {ℝ}^{n}} f ( y ; X β , Σ ) {\prod }_{i} η ( {r}_{i} ( {wy}_{i} + b ) ) d y$$

Here u is a random variable explaining the genetic background effect, following a multivariate normal distribution with zero mean and covariance matrix Var(u)=Σ=σ²K. K is a kinship matrix estimated from multi-locus genotypes. A simple IBS kinship matrix, or Lynch-Ritland kinship matrix are examples of matrices that can be used. The multivariate normal likelihood has the form,

$$f ( y ; X β , Σ ) = \frac{1}{{( 2 π )}^{n / 2} {\vert Σ \vert}^{1 / 2}} exp [ - \frac{1}{2} {( y - X β )}^{′} {Σ}^{- 1} ( y - X β ) ]$$

$$Here are some properties holding for f ( y ; X β , Σ )$$

$$f ( y + δ 1 ; X β + δ 1 , Σ ) = f ( y ; X β , Σ )$$

$$f ( α y ; α X β , {α}^{2} Σ ) = \frac{1}{{α}^{n}} f ( y ; X β , Σ )$$

$$Let \tilde{y} = \frac{1}{σ} ( y + \frac{b}{w} 1 ) , \\ then Pr ( r ; {σ}^{2} , X β , w , b ) can be reformulated as$$

$$\begin{matrix}Pr ( r ; {σ}^{2} , X β , w , b ) = {\int }_{y ∈ {ℝ}^{n}} f ( y ; X β , Σ ) {\prod }_{i} η ( {r}_{i} ( {wy}_{i} + b ) ) d y \\ = {σ}^{n} {\int }_{\tilde{y} ∈ {ℝ}^{n}} f ( σ \tilde{y} - \frac{b}{w} 1 ; X β , Σ ) \\ {\prod }_{i} η ( {r}_{i} w σ {\tilde{y}}_{i} ) d \tilde{y} \\ = {σ}^{n} {\int }_{\tilde{y} ∈ {ℝ}^{n}} f ( σ \tilde{y} ; X β + \frac{b}{w} 1 , Σ ) \\ {\prod }_{i} η ( {r}_{i} w σ {\tilde{y}}_{i} ) d \tilde{y} \\ = {\int }_{\tilde{y} ∈ {ℝ}^{n}} f ( \tilde{y} ; \frac{X β}{σ} + \frac{b}{w {σ}^{2}} 1 \frac{1}{{τ}^{2}} Σ ) \\ {\prod }_{i} η ( {r}_{i} w σ {\tilde{y}}_{i} ) d \tilde{y} \\ = Pr ( r , 1 , \frac{X β}{σ} + \frac{b}{w σ} 1 , w σ , 0 )\end{matrix}$$

Accordingly, any generative model with four parameters can be equivalently represented as two parameter model where σ²=1, b=0, involving only Xβ and w. So, if no other confounding variables are involved, the ML estimation reduces to two-dimensional optimization problem under null hypothesis, and three-dimensional one under hypothesis.

Because the exact likelihood computation is intractable for large number of samples, various approximation algorithms have been proposed to estimate the likelihood, including MCEM, MCNR, and SML methods described above. A variational approximation can provide a lower bound of exact likelihood as an approximation of likelihood.

Let y=(y₁, y₂, . . . , yₙ) be a multivariate Gaussian N (m, Σ), and let r=(r₁, r₂, . . . , rₙ)ε{−1, 1}ⁿ with the following conditional probability

$$Pr ( {r}_{i} \vert {y}_{i} ) = η ( {wy}_{i} + b ) \geq exp [ {g}_{i} + {y}_{i} {h}_{i} + {y}_{i}^{′} {K}_{i} {y}_{i} ]$$

$${g}_{i} = log σ ( {ξ}_{i} ) + \frac{1}{2} {r}_{i} b - \frac{1}{2} {ξ}_{i} + λ ( ξ ) ( {b}^{2} - {ξ}_{i}^{2} )$$

$${h}_{i} = \frac{1}{2} {r}_{i} w + λ ( {ξ}_{i} ) 2 bw$$

$${K}_{i} = - 2 λ ( {ξ}_{i} ) {w}^{2}$$

where λ(ξᵢ)=(½σ(ξᵢ))/2ξᵢ. The computation of ξᵢs is are described later.
The full joint probability becomes

$$f ( y , r ) = f ( y ) {\prod }_{i} Pr ( {r}_{i} {y}_{i} ) \geq exp ( g + {h}^{′} y + {y}^{′} Ky )$$

$$where$$

$$g = - \frac{n}{2} log ( 2 π ) - \frac{1}{2} log \vert Σ \vert - \frac{1}{2} {m}^{′} {Σ}^{- 1} m + {\sum }_{i} [ \begin{matrix}log σ ( {ξ}_{i} ) + \frac{1}{2} {r}_{i} b - \\ \frac{1}{2} {ξ}_{i} + λ ( {ξ}_{i} ) ( {b}^{2} - {ξ}_{i}^{2} )\end{matrix} ]$$

$$h = {Σ}^{- 1} m + \frac{1}{2} rw + 2 bw \cdot vec ( λ ( {ξ}_{i} ) )$$

$$K = {Σ}^{- 1} - 2 {w}^{2} diag ( λ ( {ξ}_{i} ) )$$

If we integrate it over x, from Equation 18. the marginal becomes

$$log Pr ( r ) = log {\int }_{X ∈ {ℝ}^{n}} f ( y , r ) d x \geq g + \frac{1}{2} {h}^{′} {K}^{- 1} h + \frac{n}{2} log ( 2 π ) - \frac{1}{2} log \vert K \vert$$

In order to get a more accurate variational approximation, the following EM-like procedure can be adapted. Given g, h, K, we can obtain the variational parameter ξi that maximizes the complete data log-likelihood. Then we can re-estimate the g, h, K given the variational parameter. This iterative procedure continues until the likelihood bound converges. A more detailed description is provided as follows.
1. Obtain starting values m⁽⁰⁾=m and τ⁽⁰⁾=Σ.
2. For each step) t=0, 1, 2, . . . , calculate

$$\begin{matrix}{( {ξ}_{i}^{( t )} )}^{2} = {E}_{t - 1} [ {( {wx}_{i} + b )}^{2} ] \\ = {w}^{2} ( {Σ}_{ii}^{( t )} + {( {m}_{i}^{( t )} )}^{2} ) + 2 {bwm}_{i}^{( t )} + {b}^{2}\end{matrix}$$

3. Given the variational parameters, reestimate m^{(t+1)} and Σ^{(t+1)} as follows.

$${Σ}^{( t + 1 )} = {[ {( {Σ}^{( t )} )}^{- 1} - 2 {w}^{2} diag ( λ ( {ξ}_{i}^{( t )} ) ) ]}^{- 1}$$

$${m}^{( t + 1 )} = {Σ}^{( t + 1 )} [ {( {Σ}^{( t )} )}^{- 1} {m}^{( t )} + \frac{1}{2} rw + 2 bw \cdot vec ( λ ( {ξ}_{i}^{( t )} ) ) ]$$

4. If convergence is reached set m=m^{(m+1)}, Σ=Σ^{(t+1)}, and ξᵢ=ξᵢ^{(t)}. Otherwise, repeat step 2 and 3 until convergence.
5. Compute the log-likelihood bound using the Equations thru 46 to 50.

When w is small, the lower bound is very tight but the inaccuracy becomes worse as w increases, as illustrated by Murphy. Consequently, the ML parameter of w is biased towards lower values if we simply replace the likelihood with variational bound of likelihood. Let Pr(r) be the marginal probabilities of observed values with parameters Xβ and w, and let P\tilde{r}(r) be the lower bound of the mariginal probabilities using the variational approximation. Then it follows that

$$\begin{matrix}Pr ( r ) = \int Pr ( r \vert y ) f ( y ) d y \\ = \int \frac{Pr ( r \vert y )}{\tilde{Pr} ( r \vert y )} \tilde{Pr} ( r \vert y ) f ( y ) d y \\ = \tilde{Pr} ( r ) \int \frac{Pr ( r \vert y )}{\tilde{Pr} ( r \vert y )} \tilde{Pr} ( y \vert r ) d y\end{matrix}$$

$$\begin{matrix}log Pr ( r ) - log \tilde{Pr} ( r ) = log \int \frac{Pr ( r \vert y )}{\tilde{Pr} ( r \vert y )} \tilde{Pr} ( y \vert r ) d y \\ = log \frac{\int Pr ( r \vert y ) f ( y ) d y}{\int \tilde{Pr} ( r \vert y ) f ( y ) d y}\end{matrix}$$

If we can compute the right-hand side of the equation above, then it is possible to reduce the inaccuracy of the likelihood bound. Once the variational parameter is determined, the conditional probability of observed values can be decomposed for each dimension. Pr(r|y)=ΠᵢPr(ri|yi), P\tilde{r}(r|y)=ΠᵢP\tilde{r}(ri|yi). However, P\tilde{r} (y|r) is a multivariate gaussian, and cannot be decomposed dimensionwise. The exact computation of the adjustment over high dimensions is not tractable, but we can compute the amount of adjustment approximately by decomposing the multivariate gaussian into product of uncorrelated Gaussians and applying independent corrections in each dimension.

$$\begin{matrix}\tilde{Pr} ( y \vert r ) = \tilde{Pr} ( {y}_{1} \vert r ) \tilde{Pr} ( {y}_{2} \vert {y}_{1} , r ) \tilde{Pr} ( {y}_{3} \vert {y}_{1} , {y}_{2} , r ) … \tilde{Pr} ( {y}_{n} \vert {y}_{1} , … , {y}_{n - 1} \vert r ) \\ \approx \tilde{Pr} ( {y}_{1} \vert r ) \tilde{Pr} ( {y}_{2} \vert {μ}_{1} , r ) \tilde{Pr} ( {y}_{3} \vert {μ}_{1} , {μ}_{2} , r ) … \tilde{ Pr} ( {y}_{n} \vert {μ}_{1} , … , {μ}_{n - 1} \vert r ) \end{matrix}$$

$$\begin{matrix}log Pr ( r ) - log \tilde{Pr} ( r ) \approx log \int \frac{η ( {wy}_{1} ) η ( {wy}_{2} ) … η ( {wy}_{n} )}{exp ( {g}_{1} + {y}_{1} {h}_{1} - \frac{1}{2} {K}_{1} {y}_{1}^{2} ) … exp ( {g}_{n} + {y}_{n} {h}_{n} - \frac{1}{2} {K}_{n} {y}_{n}^{2} )} \\ \tilde{Pr} ( {y}_{1} \vert r ) \tilde{Pr} ( {y}_{2} \vert {μ}_{1} , r ) … \tilde{Pr} ( {y}_{n} \vert {μ}_{1} , … , {μ}_{n - 1} r ) d y \\ = {\sum }_{i = 1}^{n} log \int \frac{η ( {wy}_{i} )}{exp ( {g}_{i} + {y}_{i} {h}_{i} - \frac{1}{2} {K}_{i} {y}_{i}^{2} )} \tilde{Pr} ( {y}_{i} \vert {μ}_{1} , … , {μ}_{i - 1} , r ) d y\end{matrix}$$

Because the variational parameters and the conditional distribution of yᵢ given μ₁, . . . , μᵢ₋₁, r are known, the above quantity can be computed numerically. For computational efficiency, the single dimensional integral can be precomputed. Let P\tilde{r}(yᵢ|μ₁, . . . , μᵢ₋₁, r) exp(−(gᵢ+yᵢhᵢ−½Kᵢyᵢ²)) be a normal pdf following N( μ̅, σ̅²) and normalization factor Z. Then we need to precompute,

$$s ( w , \overline{μ} , \overline{σ} ) = {\int }_{- ∞}^{∞} η ( wy ) \frac{1}{\sqrt{2 π} σ} exp ( - \frac{{( y - \overline{μ} )}^{2}}{2 {\overline{σ}}^{2}} ) d y$$

$$Let z = ( y - \overline{μ} ) / \overline{σ} , then$$

$$\begin{matrix}s ( w , \overline{μ} , \overline{σ} ) = \frac{1}{\sqrt{2 π}} {\int }_{- ∞}^{∞} η ( w \overline{σ} z + w \overline{μ} ) exp ( - \frac{1}{2} {z}^{2} ) d y \\ = τ ( w \overline{σ} , w \overline{μ} ) \\ = τ ( {w}^{′} , {b}^{′} )\end{matrix}$$

Thus, it is sufficient to make a precomputed table over two dimensional space of w′ and b′ in τ, instead of the dimensional space of s. When w is large, the logit function can be approximated as a step function. In this case, τ(w′, b′) can be approximated as follows:

$$\begin{matrix}τ ( {w}^{′} , {b}^{′} ) = \frac{1}{\sqrt{2 π}} {\int }_{- ∞}^{∞} η ( {w}^{′} z + {b}^{′} ) exp ( - \frac{1}{2} {z}^{2} ) d y \\ \approx \frac{1}{\sqrt{2 π}} {\int }_{- {b}^{′} / {w}^{′}}^{∞} exp ( - \frac{1}{2} {z}^{2} ) d y \\ = Φ ( \frac{{b}^{′}}{{w}^{′}} )\end{matrix}$$

This approximation is useful when b′ is out of the range due to large w′. On the other hand, when w′ is very small, log Pr(r) can be very accurately approximated by log P\tilde{r}(r).

Another possible approach to estimate the likelihood is to use importance sampling. Previous approaches for importance sampling do not specify the distribution to sample, but the distribution obtained from a variational approximation can serve as a good proposal distribution.

### Association Identification:

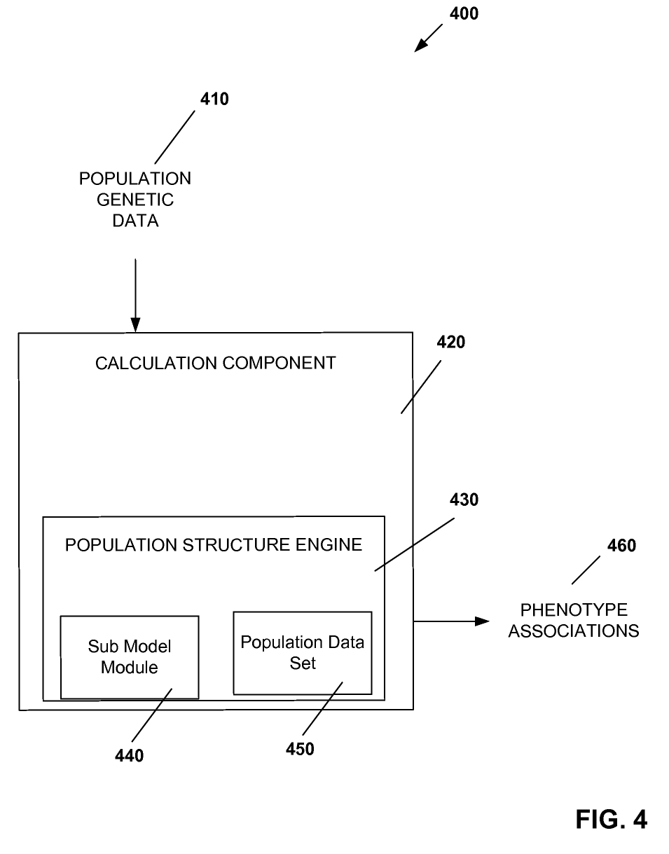

FIG. 3 schematically illustrates one example of a system 300 for use in identifying phenotypes. As is shown in FIG. 4, system 300 calculation prediction component 320 having population structure engine 330 executing sub-model module 340. In an illustrative operation, calculation component 320 receives input data (e.g., population genetic data 310) which is operatively processed by population structure engine 330 executing sub-model module 340 to generate phenotype associations data 350.

In an illustrative implementation, population structure engine 330 can comprise a computing environment operative to generate one or more graphical models. The graphical model can exploit one or more selected sub-models when identifying phenotypes including but are not limited to the derivation of a population structure sub-model (e.g., as operative by sub-model module 340) for use in correlating predictor variables and target variables.

FIG. 4 schematically illustrates another example of a system 400 for use in identifying phenotypes. As is shown in FIG. 4, system 400 comprises calculation component 420 having population structure engine 430 operating sub-model module 440 processing population data set 450. In an illustrative operation, calculation component 420 receives input data (e.g., population genetic data 410) which is operatively processed by population structure engine 430 executing sub-model module 440 processing population data set 450 to generate phenotype associations data 460.

In an illustrative implementation, population structure engine 430 can comprise a computing environment to generate one or more graphical models. The graphical model can exploit one or more selected sub-models when identifying phenotypes including but are not limited to the derivation of a population structure sub-model (e.g., as operative by sub-model module 440) for use in correlating predictor variables and target variables. Illustratively, the population structure sub-model allows for the correlation of genotype data with phenotype data when identifying phenotypes utilizing population data set 450.

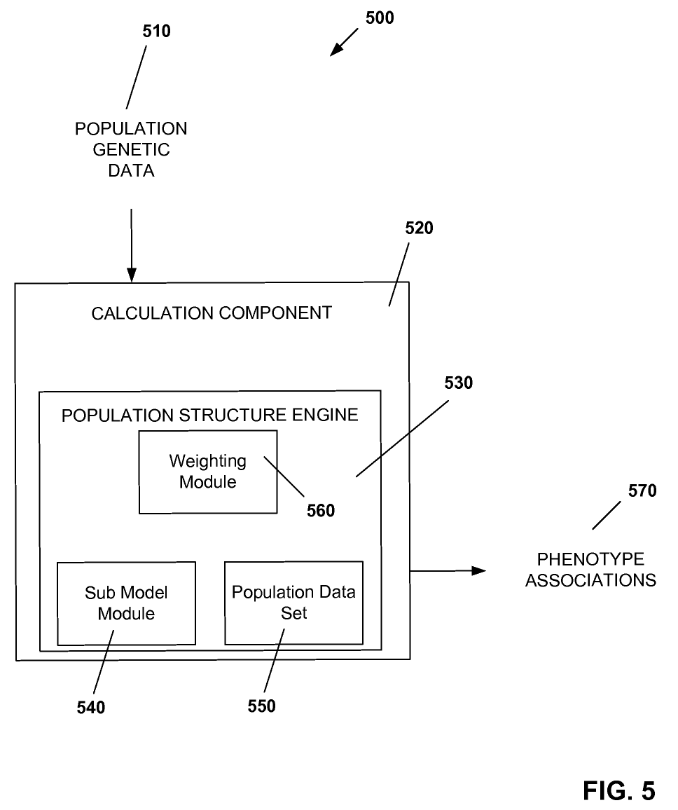

FIG. 5 schematically illustrates another example of a system 500 for use in identifying phenotypes. As is shown in FIG. 5, system 500 comprises calculation component 520 having population structure engine 630 operating on sub-model module 5640, population data set 550, and deploying weighting module 660. In an illustrative operation, calculation component 520 receives input data (e.g., population genetic data 510) which is operatively processed by population structure engine 530 executing sub-model module, processing population data set 550, and deploying weighting module 560 to identify phenotype association data 570.

In an illustrative implementation, population structure engine can comprise a computing environment operable to generate one or more graphical models. The graphical models can be utilized by sub-model module 540 when identifying phenotypes. In the illustrative implementation, the selected exemplary sub-model can comprise a population structure sub-model illustratively operative to apply the generated graphical models to identify correlations using weighting module 560 among the input data as part of phenotype prediction.

The systems described above can be implemented in whole or in part by electromagnetic signals. These manufactured signals can be of any suitable type and can be conveyed on any type of network. For instance, the systems can be implemented by electronic signals propagating on electronic networks, such as the Internet. Wireless communications techniques and infrastructures also can be utilized to implement the systems.

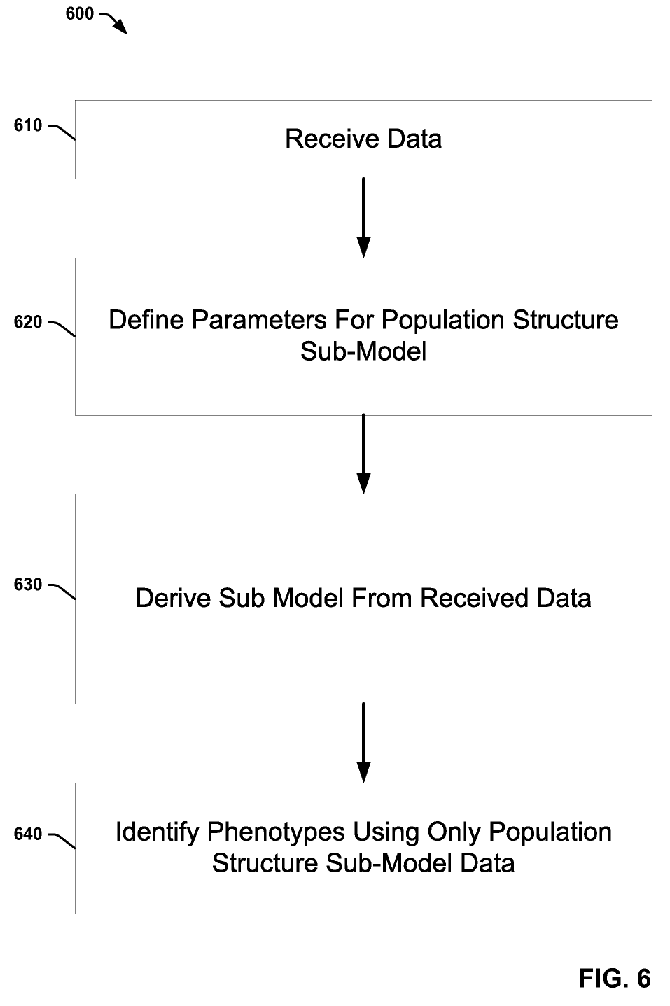

FIG. 6 is a flow diagram of one example of a method 600 for use when identifying phenotypes. The method 600 can be encoded by computer-executable instructions stored on computer-readable media. Processing begins at block 610 where data is received for processing at block 620 where parameters for a population structure sub-model are defined. Processing then proceeds to block 630 where the sub-model is derived using the received data. Phenotypes are then identified using only population structure sub-model data.

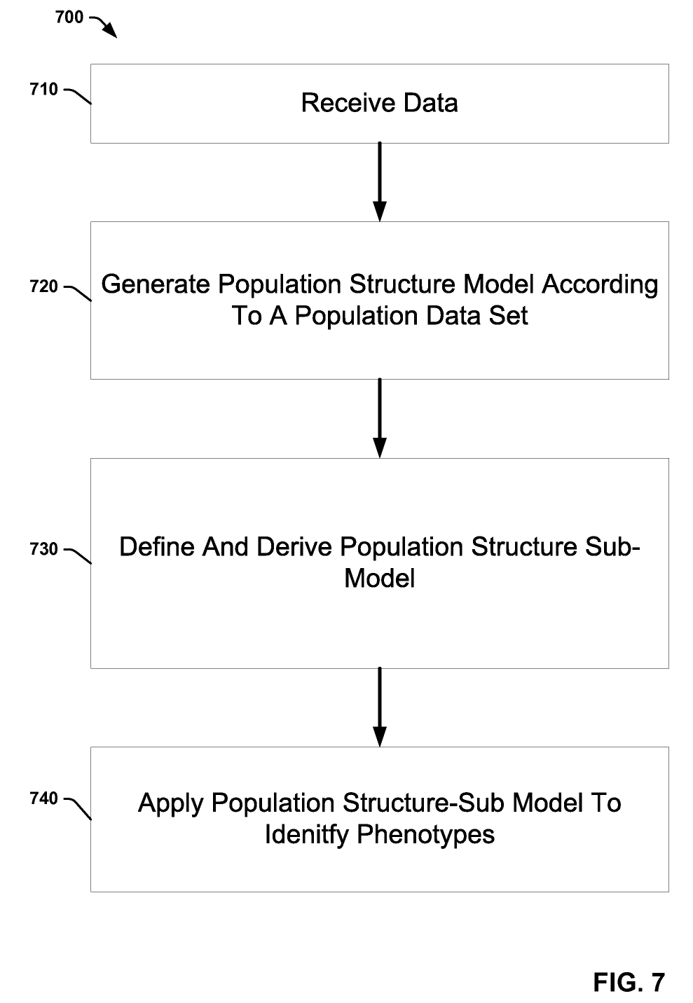

FIG. 7 is a flow diagram of one example of a method 800 for identifying one or more phenotypes. The method 700 can be encoded by computer-executable instructions stored on computer-readable media. Processing begins at block 710 where data is received for processing at block 720 where a population structure model according to a selected population data set is generated. Processing proceeds to block 730 where a population structure sub-model is defined and derived having selected predictor variables that are determined. Processing then proceeds to block 740 where the population sub-model is applied to the received data to predict one or more phenotypes.

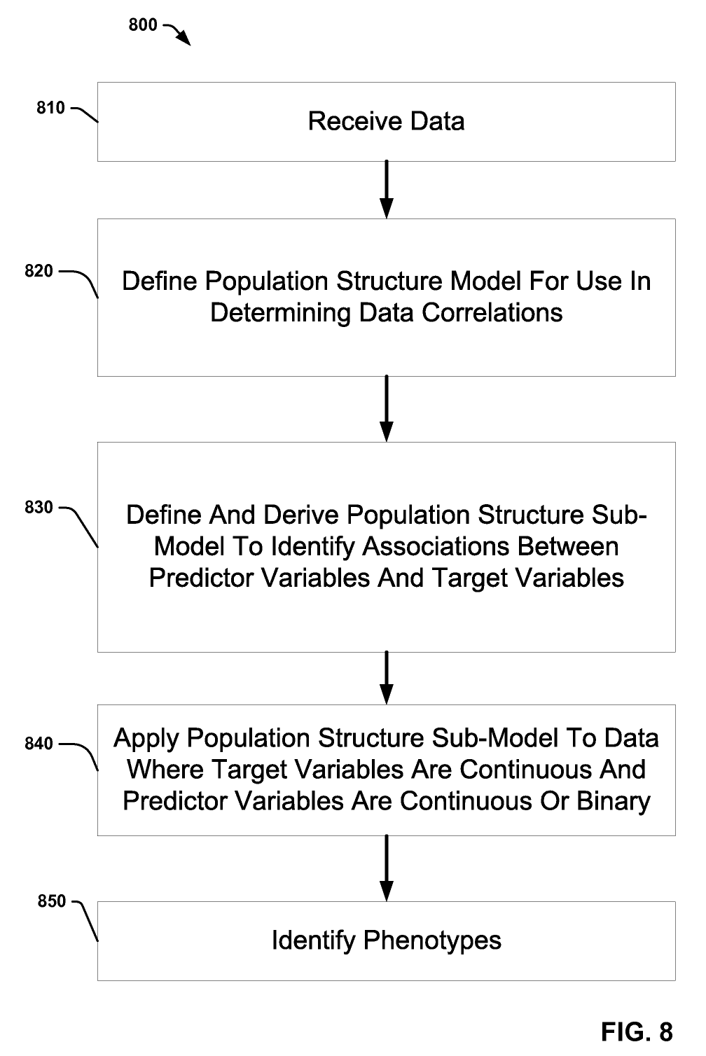

FIG. 8 is a flow diagram of one example of a method 800 identifying one or more phenotypes. The method 800 can be encoded by computer-executable instructions stored on computer-readable media. Processing begins at block 810 where data is received for processing at block 820 where a population structure model for use in determining data correlations is defined. Processing proceeds to block 830 where a population structure sub-model is defined and derived to identify associations between predictor variables and target variables. The defined population structure sub-model is then applied to the received data, where in an illustrative implementation, the target variables are continuous or binary and the predictor variables are continuous or binary. Phenotypes are then identified using the derived correlations between the predicator and target variables at block 850.

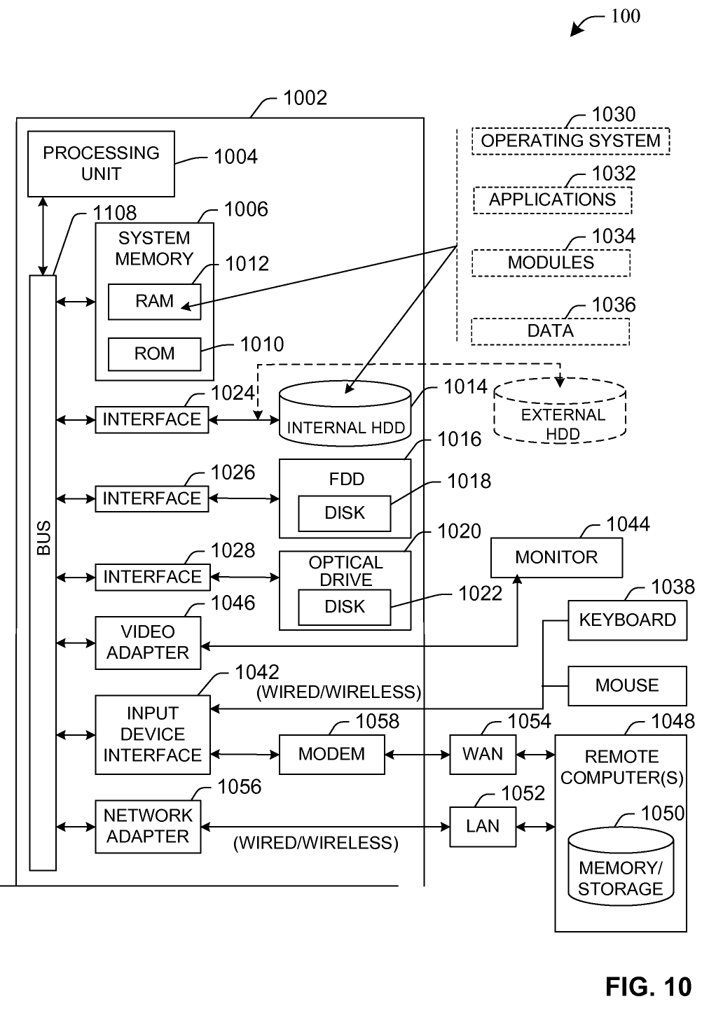

FIG. 10 is a flow diagram of one example of a method 900 of identifying a phenotype. The method 900 can be encoded by computer-executable instructions stored on computer-readable media. Processing begins at block 910 where data is received for processing at block 910. At block 920 a population structure model is defined. Processing then proceeds to block 930 a population structure sub-model is generated using the received data. Data correlations are then determined between identified predictor variables and target variables at block 940. Phenotypes are then identified using population structure sub-model and population genetic data according to the correlations determined by the generated population structure sub-model.

The exemplary optimization component can employ one of numerous methodologies for learning from data and then drawing inferences from the models so constructed (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

Methods also include methods for capture of logical relationships such as theorem provers or more heuristic rule-based expert systems. Inferences derived from such learned or manually constructed models can be employed in optimization techniques, such as linear and non-linear programming, that seek to maximize some objective function.

The optimization component, can take into consideration historical data, and data about current context. Policies can be employed that consider including consideration of the cost of making an incorrect determination or inference versus benefit of making a correct determination or inference. Accordingly, an expected-utility-based analysis can be used to provide inputs or hints to other components or for taking automated action directly. Ranking and confidence measures can be calculated and employed in connection with such analysis.

It should be appreciated that optimization is dynamic and policies selected and implemented will vary as a function of numerous parameters; and thus the optimization component is adaptive. In the illustrative implementation, a gradient descent can be employed to determine the global maximum described in block 1040.

The methods can be implemented by computer-executable instructions stored on one or more computer-readable media or conveyed by a signal of any suitable type. The methods can be implemented at least in part manually. The steps of the methods can be implemented by software or combinations of software and hardware and in any of the ways described above. The computer-executable instructions can be the same process executing on a single or a plurality of microprocessors or multiple processes executing on a single or a plurality of microprocessors. The methods can be repeated any number of times as needed and the steps of the methods can be performed in any suitable order.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the subject matter described herein can be practiced with most any suitable computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing some of the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

Moreover, it is to be appreciated that various aspects as described herein can be implemented on portable computing devices (e.g., field medical device), and other aspects can be implemented across distributed computing platforms (e.g., remote medicine, or research applications). Likewise, various aspects as described herein can be implemented as a set of services (e.g., modeling, predicting, analytics, etc.).

FIG. 10 illustrates a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

More particularly, and referring to FIG. 10, an example environment 1000 for implementing various aspects as described in the specification includes a computer 1002, the computer 1002 including a processing unit 1004, a system memory 1006 and a system bus 1008. The system bus 1008 couples system components including, but not limited to, the system memory 1106 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1116 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

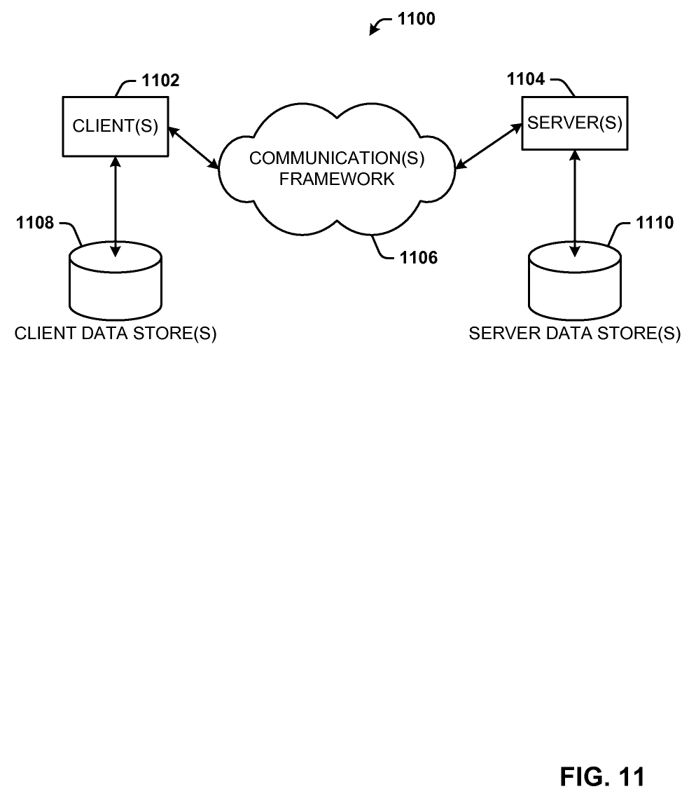

Referring now to FIG. 11, there is illustrated a schematic block diagram of an exemplary computing environment 1100 in accordance with the subject invention. The system 1100 includes one or more client(s) 1102. The client(s) 1102 can be hardware and/or software (e.g., threads, processes, computing devices). The client(s) 1102 can house cookie(s) and/or associated contextual information by employing the subject invention, for example. The system 1100 also includes one or more server(s) 1104. The server(s) 1104 can also be hardware and/or software (e.g., threads, processes, computing devices). The servers 1104 can house threads to perform transformations by employing the subject invention, for example. One possible communication between a client 1102 and a server 1104 can be in the form of a data packet adapted to be transmitted between two or more computer processes. The data packet may include a cookie and/or associated contextual information, for example. The system 1100 includes a communication(s) framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented method that facilitates genotype-phenotype association identification, comprising:
receiving data representative of population genetic and phenotype data;
generating a graphical model of the data comprising a non-trivial population structure sub-model; and
applying the graphical model to the population genetic and phenotype data to identify associations between a genotype and one or more phenotypes.

2. The method as recited in claim 1, further comprising generating a logit observation model, wherein parameters of the graphical model are learned from data using a variational approximation.

3. The method as recited in claim 1, further comprising defining one or more predictor variables.

4. The method as recited in claim 1, further comprising defining one or more phenotype variables.

5. The method as recited in claim 3, further comprising defining the one or more predictor variables as continuous predictor variables.

6. The method as recited in claim 3, further comprising defining the one or more predictor variables as binary predictor variables.

7. The method as recited in claim 4, further comprising defining the one or more target variables as continuous target variables.

8. The method as recited in claim 4, further comprising defining the one or more target variables as binary target variables.

9. The method as recited in claim 1, further comprising deriving a population structure sub-model from a selected pedigree and the population genetic data.

10. A computer implemented method that facilitates genotype-phenotype association identification, comprising:
receiving data representative of population genetic and phenotype data;
generating a graphical model of the data comprising a population structure sub-model; and
applying the graphical model to the population genetic and phenotype data using a variational approximation to identify associations between a genotype and one or more phenotypes.

11. A system that facilitates genotype-phenotype association identification, the system stored on computer-readable media, the system comprising:
a calculation component configured to identify a genotype-phenotype association by applying a selected population structure sub-model;
a population structure engine operable to generate a population structure sub-model utilizing one or more selected graphical models and applying the population structure sub-model to population data to identify the one or more genotype-phenotype association.

12. The system as recited in claim 11, wherein the population data comprises population genetic data.

13. The system as recited in claim 11, further comprising a data store comprising data representative of population data.

14. The system as recited in claim 13, wherein the genotype-phenotype association is identified by deploying the population structure sub-model.

15. The system as recited in claim 14, wherein the genotype-phenotype association is identified by processing one or more predictor variables and/or one or more target variables.

16. The system as recited in claim 11, wherein the calculation component and the population structure sub-model comprise one or more portions of a computing application.

17. The system as recited in claim 11, wherein the population structure sub-model is generated using input data representative of population genetic data.

18. The system as recited in claim 11, wherein the calculation component comprises a computing application operable on a computing environment.

19. The system as recited in claim 11, wherein the population structure engine comprises a computing application.

20. The system as recited in claim 11, wherein the system comprises a computing application.
